(19) United States
(12) Patent Application Publication
(10) Pub. No.: US 2004/0083494 A1
(43) Pub. Date: Apr. 29, 2004

(54) System for delivering contents and method of doing the same

(75) Inventor: Akira Sakurai, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/685,468

(22) Filed: Oct. 16, 2003

(30) Foreign Application Priority Data
Oct. 16, 2002 (JP) 2002-301716

(51) Int. Cl. H04J 3/22; H04J 3/16; H04L 12/28; H04N 7/173; H04N 7/16

(52) U.S. Cl. 725/126; 725/118; 725/148; 725/1; 370/431; 370/468

(57) ABSTRACT

A system for delivering contents to a user, includes (a) a content server which provides a content a user selected, to the user, (b) a user's terminal which transmits an indication of a user's desired content among contents provided by the content server, to the content server, and (c) a network system which assigns a band necessary for transmission of the content to a channel through which the content is transmitted from the content server to the user's terminal, only during the content is being transmitted, receives a content fee from the user, pays the content fee to the content server, and receives a fee for assuring the band and transmitting the content to the user on behalf of the content server, from the content server.

### BACKGROUND OF THE INVENTION

1. Field of the Invention

The invention relates to a system for delivering contents to a user who purchased the contents, through a network system, and further to a method of doing the same.

2. Description of the Related Art

With development of the Internet, various programs and/or audio or image contents are presented through the Internet. A user can download them directly through a communication network by means of a communication terminal such as a personal computer, a cellular phone, a game player terminal or a personal digital assistant.

When contents are non-gratuitous, a user pays a fee to a content-provider when he/she purchases the contents. However, a user seldom pays a fee directly to a content-provider. A third party frequently pays a fee to a content-provider on behalf of a user in order to smooth payment. For instance, if a user pays by a credit card, a credit card company pays a fee to a content-provider, in which case, the credit card company charges a user of a sum of a fee at which a user purchased the contents and a communication fee to be paid to a network company.

With recent increase in a communication speed in a network, reduction in communication fees and increase in interest to broad-band internet, network service for keeping a user to be always connected to a network, such as ADSL (Asymmetrical Digital Subscriber Line) or FTTH (Fiber to the Home), which provides a higher communication rate at lower costs than conventional dial-up type service, broadly spreads.

Such ADSL or FTTH provides service by which a user can make access to an object at a high rate. In contrast, a best-effort type network such as Internet is designed to have a communication rate variable in accordance with network conditions. That is, a frequency band at end-to-end is not assured in a best-effort type network. Hence, a best-effort type network is accompanied with a problem that a throughput at which data is transferred when a content is downloaded is significantly reduced, if traffic becomes high in the network, for instance, during night.

Such significant reduction in a throughput at which data is transferred causes a problem of increase in a time necessary for transmitting a content, and further causes a problem that voices and images cannot be transmitted at real-time, for instance, in streaming or in distribution of live images, resulting in degradation in image quality. Accordingly, even if a company which pays a fee to a content-provider on behalf of a user starts a business for providing non-gratuitous contents to a user, the above-mentioned reduction in a throughput at which data is transferred would be a bar to success of the business.

Many proposals have been made to solve the problem of reduction in a throughput at which data is transferred.

Japanese Patent Application Publication No. 2001-175757 has suggested a system for delivering non-gratuitous contents.

FIG. 1 is a block diagram of the suggested system. The system is comprised of a user's terminal 101 through which a user purchases contents, a provider's server 103 through which a content-provider transmits contents to the user's terminal 101, a credit company 104 which settles accounts, and a network 105 through which the provider's server 103 transmits contents to the user's terminal 101.

A user makes access to the provider's server 103 through the terminal 101, and selects a content or contents. Then, a user transmits indication of selected contents and conditions 106 for transmitting the contents to the user, to the provider's server 103. Herein, the conditions 106 include a data-transmission rate (a band) at which data is transmitted through the network 105.

The provider's server 103 indicates a band 107 to the network 105 in accordance with the conditions 106 received from the user's terminal 101, and then, transmits the contents to the user through the network 105.

The credit company 104 charges the user separately of a fee for the contents and a content-transmission fee associated with the conditions 106. The user pays the fee to the credit company 104. A content-transmission fee is higher as a time for transmitting a content is shorter. Then, the credit company 104 pays the content fee 109 to the provider's server 103, and pays the content-transmission fee to an administrator of the network 105.

In the system illustrated in FIG. 1, assuming that a user purchases moving images of live performance, a user transmits the conditions 106 for transmitting contents to the user in a band determined in accordance with reproduction of images such as resolution of images, to the provider's server 103. Accordingly, the provider's server 103 can reserve a band in the network through a server (not illustrated) used for reserving a band, and transmit the contents 102 to the user's terminal 101 in accordance with the conditions 106 indicated by the user.

After the contents 102 have been transmitted to the user, the server used for reserving a band releases the band having been assigned to data-transmission between the user's terminal 101 and the provider's server 103.

Japanese Patent Application Publication No. 2002-44133 has suggested another system for delivering non-gratuitous contents to a user.

FIG. 2 is a block diagram of the suggested system. A handy terminal 121 is designed to be able to be connected to the internet 123 through a cellular network 122. A server 124 of a communication service company, which assures a channel in the cellular network 122 and charges a user of communication fee, is connected to the cellular network 122. To the internet 123 are connected an internet service provider (ISP) 125 providing a service for assisting a user to connect to the internet 123, a content-provider 127 having a content server 126 storing contents therein, and an administration server 128 administrating the content-provider 127.

It is now assumed that the handy terminal 121 receives contents stored in the content server 126.

First, in order to receive contents from the content server 126, the handy terminal 121 makes contract called SLA contract with the server 124, the ISP 125 and the content-provider 127. The SLA contract is a contract guaranteeing that a time after requesting the content-provider 127 to transmit a content to a user, until the user receives the content should be within a predetermined period of time.

Then, the handy terminal 121 transmits information indicative of a category a content which a user intends to purchase belongs to, to the content-provider 127. The server 124 assures a channel in the cellular network 122 in accordance with the category which the handy terminal 121 transmitted to the content-provider 127, and starts settling accounts for SLA contract. When the server 124 receives notification of content receipt from the handy terminal 121, the server 124 releases the band, and finishes account settlement.

In the system illustrated in FIG. 2, the server 124 of a communication service company charges a user of a fee, based on the SLA contract. A fee may be dependent on data volume transmitted between the handy terminal 121 and the content-provider 127, or may be fixed monthly.

Japanese Patent Application Publication No. 2002-158656 has suggested still another system for delivering non-gratuitous contents to a user.

FIG. 3 is a block diagram of the suggested system. A provider network 143 is comprised of access routers 144 and 146, core routers 148 and 149, and a fee-charging server 150. A user's terminal 141 is connected to the access router 144 through a dial-up line 142. A server storing contents therein is connected to the access router 146 through a line 147. When the user's terminal 141 downloads contents stored in the server 145, packets are transmitted to the user's terminal 141 from the server 145 through the access router 146, the core routers 148 and 149, and the access router 144. The access router 144 transmits information indicative of a fee to the fee-charging server 150 which fee is determined in accordance with a time during which communication quality is assured to the provider network 143.

In accordance with the system illustrated in FIG. 3, when the user's terminal 141 downloads a content, a user can request the provider network 143 to assure communication quality. On receipt of such a request from the user's terminal 141, the access router 144 causes the access router 146 and the core routers 148 and 149 to assure communication resource such as a band. After such communication resource has been assured, the access router 144 informs the user's terminal 141 that the requested communication quality is assured, and simultaneously, informs the fee-charging sever 150 of date and time from which communication starts.

As shown in the systems illustrated in FIGS. 1 to 3, a network company has conventionally charged a user of a communication fee variable in accordance with a period in which contents a user selected are transmitted to the user from the server 145, or a fixed fee. A band resource in a communication network through which contents are transmitted is necessary to be assured during a period in which contents a user selected are transmitted to the user from the server 145. In brief, a network company has conventionally charged a user of a communication fee determined in accordance with a period in which contents are transmitted, and assured a necessary band for the user.

However, many users recently select a fixed fee as a fee to be paid for a service of keeping the users to be always connected to the internet. In a fixed-fee system, if a user pays a predetermined communication fee, he/she can make connection with the internet at any time. Accordingly, it is now difficult to provide a service of assuring a channel during an indicated period and separately charging a user of a communication fee determined in accordance with the period, as a business.

Japanese Patent Application Publication No. 2001-320372 has suggested a system for administrating subscribers, including a mobile station movable and meeting medium standards, a network controlling traffic of the mobile station to thereby control hand-off, re-arranging data in accordance with matched conditions by transmitting data to and receiving data from a packet network on receipt of a request from the mobile station, and transmitting medium to other mobile stations, a call-controller controlling calls between the network and a later mentioned subscriber's server, and a subscriber's server administrating mobility and an account-settling function of the mobile station.

Japanese Patent Application Publication No. 2002-199365 has suggested a system for delivering image data to a user, including a server storing still and moving image data, and having a function of settling account, an intermediate server temporarily storing image data therein, and a computer network system through which the server and the intermediate server can make access to each other. Still and moving image data is transmitted to a user upon a request of the user, and the user is charged of a fee in accordance with data volume. When a user requests the intermediate server to transmit image data to the user, the intermediate server transmits information for identifying both the user and the image data, to the server. The server charges the user of a content-fee, based on the received information.

### SUMMARY OF THE INVENTION

In view of the above-mentioned problems in the conventional systems, it is an object of the present invention to provide a system for delivering a non-gratuitous content to a user, assuring a band for content-transmission, without separately charging the user of a fee for assuring a band resource.

In one aspect of the present invention, there is provided a system for delivering contents to a user, including (a) a content server which provides a content a user selected, to the user, (b) a user's terminal which transmits an indication of a user's desired content among contents provided by the content server, to the content server, and (c) a network system which assigns a band necessary for transmission of the content to a channel through which the content is transmitted from the content server to the user's terminal, only during the content is being transmitted, receives a content fee from the user, pays the content fee to the content server, and receives a fee for assuring the band and transmitting the content to the user on behalf of the content server, from the content server.

For instance, the content server shows the content fee to the user, guaranteeing to assure the band and transmitting the content to the user, and provides the content at the content fee to the user.

It is preferable that the network system includes a first server for assigning the band to the channel.

In the present invention, the content server which provides various contents through the network system shows a content fee to a user, assuring a band used for transmission of a content which the user purchases and guaranteeing that the content is transmitted to an indicated address. The user's terminal selects one or more content(s) among contents provided by the content server, and pays the content fee to the network system. The network system pays the content fee to the content server, and receives a fee for assuring the band and transmitting the content to the user on behalf of the content server, from the content server. Thus, the content is transmitted to the user only if the user pays the content fee to the network system.

Hence, the user does not have a feeling of separately paying a transmission fee for transmitting a content to the user, and can purchase a content without visiting a shop. In addition, a band used for reproducing the content is assured even in a best-effort type network in which a band is not assured, such as Internet, and hence, it would be possible to transmit data of streaming of voice and moving images or live performance at desired rate and quality.

Furthermore, since a band is assured during the content is being transmitted, it is not necessary for an administrator of the network system to newly construct a network used only for delivering contents, such as CDN (Contents Delivery Network). Since the system for delivering non-gratuitous contents can be used through the use of an existing network, initial costs for constructing the system can be significantly reduced.

In accordance with the present invention, an administrator of the network system can cooperate with a content-provider having the content server to begin a content-selling business, it is not necessary for the administrator to store contents in a server and administrate contents. By cooperating with many content servers, an administrator enables a user to select his/her favorite content among a lot of contents.

In addition, a content-provider can readily provide real-time data such as live performance data by storing contents in a content server arranged in a network.

Since an administrator of the network system carries out assignment of network resources within a network, the administrator can be distinguished from competitors, and hence, increase his/her client users.

The network system may be comprised of routers and workstations arranged away from one another, in which case, they act as an apparatus by making communication to one another.

For instance, the user's terminal may be comprised of a wireless terminal, and receives the content from the content server through a wireless base station and one or more routers.

When the user's terminal is comprised of a wireless terminal, though a band for making communication with a wireless base station is frequently narrow, it is guaranteed that a band for transmission of a content is assured and the thus transmitted content can be well reproduced. In addition, a requisite band is assured only during a time zone in which a content is transmitted, and hence, other users can use the band except the time zone.

The user's terminal is not always to be a wireless terminal, but may be designed to make communication with the network system through a wire such as an existing telephone line, a line used only for the user's terminal or an optic cable.

The content server may be designed to detect traffic in a channel between the content server and the user's terminal, and calculate a higher content fee as the detected traffic is higher, as a band necessary for reproducing the content is broader than a band usually acquired during a time zone in which the content is transmitted, or as transmission of the content needs a longer period of time, the thus calculated content fee being shown to the user's terminal.

A content fee shown to the user's terminal by the content server is variable in dependence on traffic on a channel. The content server enables the user to purchase a content at his/her desired timing. Thus, the user can purchase a content at a reasonable fee associated with a time zone, and in addition, the user pays a fee only to the network system.

The user's terminal may be designed to designate a fee at which the user determines to purchase the content, in which case, the network system makes a contract with the user when the content fee becomes equal to or smaller than the user's designated fee.

When a content fee is variable as mentioned above, the user can designate his/her desired content fee. A content-purchase contract is established when a content fee suggested by the content server becomes equal to or smaller than the user's designated fee. Hence, the user may purchase a content if a content fee becomes slightly smaller than a present fee, or decide unless a content fee becomes smaller than his/her desired fee. Thus, the user substantially controls a content fee. In addition, since account for a content is automatically settled, the user can get a content, even if he/she cannot handle his/her terminal when a content-purchase contract is established.

The user's terminal may be designed to designate a fee at which the user determines to purchase the content, and inform the content server that the user purchases the content when informed that the content fee becomes equal to or smaller than the user's designated fee, in which case, the network system informs the user's terminal that the content fee becomes equal to or smaller than the user's designated fee, and considers that a purchase contract of the content is established when the user's terminal informs the network system that the user determines to purchase the content.

In the previously mentioned embodiment, the user can automatically purchase a content if a content fee becomes equal to or smaller than the user's designated fee. Accordingly, the content the user purchased can be automatically transmitted to the user.

In the present embodiment, when a content fee becomes equal to or smaller than the user's designated fee, the user is so informed. Hence, the user may decide to purchase the content, or re-arrange his/her designated fee. If the user cannot respond to a notification that a content fee becomes equal to or smaller than the user's designated fee, because the user is out, for instance, a contract is not established for a content to be reproduced at real-time. Accordingly, the user does not fail to get an opportunity of reproducing a content which requests the user to be in front of his/her user's terminal when reproducing. If it is not convenient for the user to receive a content as from a moment at which the user receives a notification that a content fee becomes equal to or smaller than the user's designated fee, because he/she is just going out, for instance, the user can postpone establishment of a content-purchase contract.

The network system may include content-relay devices arranged in the network system, the content-relay devices each temporarily storing the content transmitted from the content server, by predetermined volume, and transmitting the content stored therein to a designated address by the predetermined volume, and the network system may select one of the content-relay devices having a band at which a content can be transmitted to a group of user's terminals which jointly purchase a particular content, assure a band resource used for a single user for transmitting the particular content between the selected content-relay device and the content server, and further assure a band resource for transmitting the particular content between the selected content-relay device and each of the group of user's terminals.

The content server may be designed to indicate both a fee at which the user can solely purchase a content and a fee at which a predetermined number of users can jointly purchase the content, and provide the content to the user or users at a fee selected by the user or users.

If a plurality of users jointly purchases a content, a fee for assuring a band is reduced by assuring a band used only for a single user between the content server and the content-relay device, though transmission of a content starts with slight delay. Thus, a fee for assuring a band among a total fee can be reduced.

If the content-relay device transmits a content to a plurality of user's terminals after storing all data of the content therein, the content-relay device has to have a large-capacity memory, and in addition, the content-relay device cannot start transmission of a content until all data of the content has been stored in a memory, resulting in much delay. Hence, in the above-mentioned embodiment, the content server divides a content into a plurality of pieces, and transmits the pieces to the content-relay devices, which then transmits the pieces to each of the user's terminals. Even if a lot of users jointly purchase a content, a band only for a single user is assured for a channel between the content server and the content-relay devices, ensuring much reduction in traffic in a network.

In another aspect of the prevent invention, there is provided a method of delivering contents to a user in a content-delivering system including a content server storing contents therein, a user's terminal which purchases a content among the contents stored in the content server, and a network system through which the content server and the user's terminal makes communication with each other, including (a) the user's terminal transmitting an indication of a user's desired content among the contents provided by the content server, to the content server, (b) the network system assigning a band necessary for transmission of the content to a channel through which the content is transmitted from the content server to the user's terminal, only during the content is being transmitted, (c) the network system receiving a content fee from the user, (d) the network system paying the content fee to the content server, and (e) the network system receiving a fee for assuring the band and transmitting the content to the user on behalf of the content server, from the content server.

It is preferable that the method further includes (f) the content server showing the content fee to the user, guaranteeing to assure the band and transmitting the content to the user, the content being provided at the content fee to the user.

It is preferable that the user's terminal is comprised of a wireless terminal, receiving the content from the content server through a wireless base station and one or more routers.

It is preferable that the method further includes step of the content server detecting traffic in a channel between the content server and the user's terminal, and the content server calculating a higher content fee as the detected traffic is higher, as a band necessary for reproducing the content is broader than a band usually acquired during a time zone in which the content is transmitted, or as transmission of the content needs a longer period of time, the thus calculated content fee being shown to the user's terminal.

It is preferable that the method further includes the step of the user's terminal designating a fee at which the user determines to purchase the content, and the network system making a contract with the user when the content fee becomes equal to or smaller than the user's designated fee.

It is preferable that the method further includes the steps of the user's terminal designating a fee at which the user determines to purchase the content, the user's terminal informing the content server that the user purchases the content when informed that the content fee becomes equal to or smaller than the user's designated fee, the network system informing the user's terminal that the content fee becomes equal to or smaller than the user's designated fee, and the network system considering that a purchase contract of the content is established when the user's terminal informs the network system that the user determines to purchase the content.

It is preferable that the network system includes content-relay devices arranged in the network system, in which case, it is preferable that the method further includes the content-relay devices each temporarily storing the content transmitted from the content server, by predetermined volume, the content-relay devices each transmitting the content stored therein to a designated address by the predetermined volume, the network system selecting one of the content-relay devices having a band at which a content can be transmitted to a group of user's terminals which jointly purchase a particular content, the network system assuring a band resource used for a single user for transmitting the particular content between the selected content-relay device and the content server, and the network system assuring a band resource for transmitting the particular content between the selected content-relay device and each of the group of user's terminals.

It is preferable that the method further includes the step of the content server indicating both a fee at which the user can solely purchase a content and a fee at which a predetermined number of users can jointly purchase the content, providing the content to the user or users at a fee selected by the user or users.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a block diagram of a conventional system for delivering non-gratuitous contents.

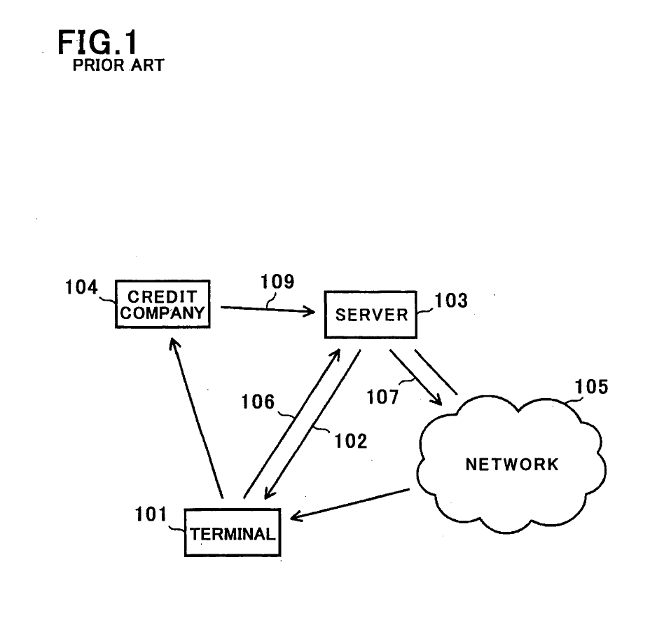

FIG. 2 is a block diagram of another conventional system for delivering non-gratuitous contents.

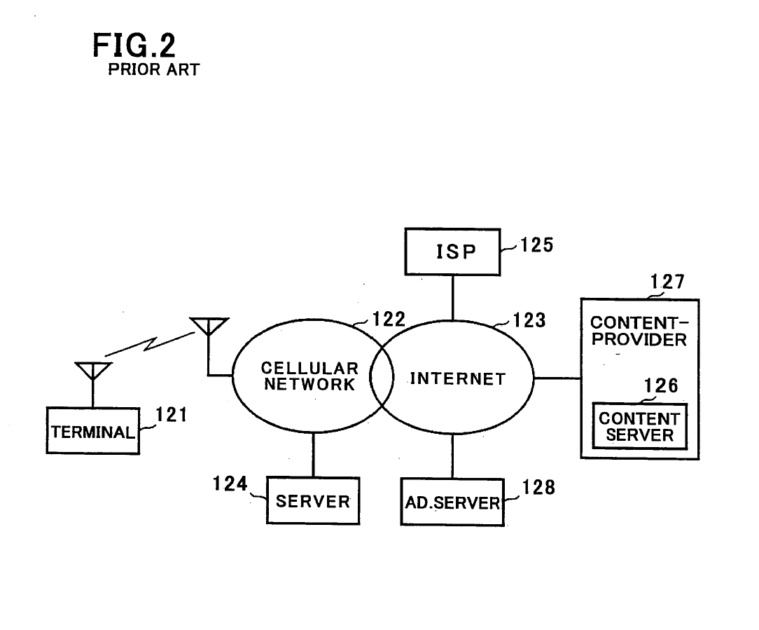

FIG. 3 is a block diagram of still another conventional system for delivering non-gratuitous contents.

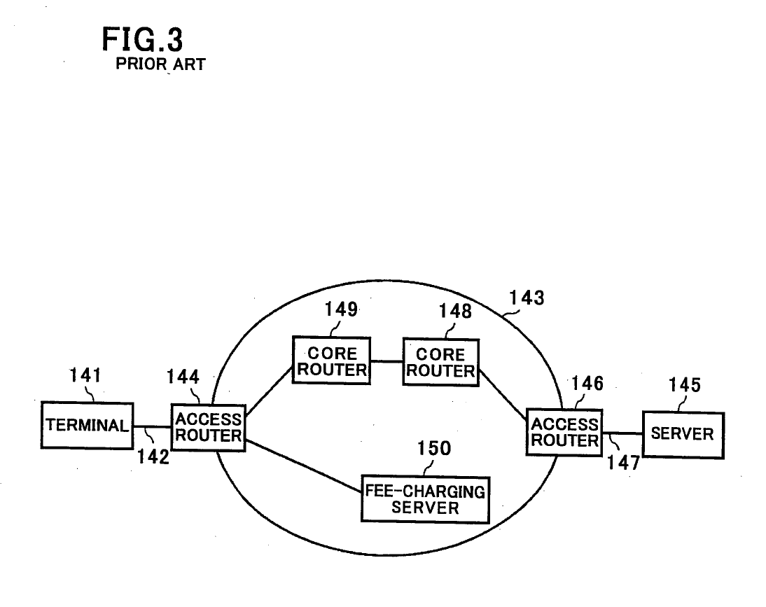

FIG. 4 is a block diagram of a system for delivering non-gratuitous contents, in accordance with the first embodiment of the present invention.

FIG. 5 illustrates a relation between a user, an administrator and a content-provider in the first embodiment.

FIG. 6 is a flow-chart of an operation of the user's terminal in the first embodiment.

FIG. 7 is a flow-chart of an operation of the content server in the first embodiment.

FIG. 8 is a flow-chart of an operation of the second server in the first embodiment.

FIG. 9 is a flow-chart of an operation of the second server in the first embodiment.

FIG. 10 is a flow-chart of an operation of the first server in the first embodiment.

FIG. 11 is a block diagram of a system for delivering non-gratuitous contents, in accordance with the second embodiment of the present invention.

FIG. 12 is a block diagram of a system for delivering non-gratuitous contents, in accordance with the third embodiment of the present invention.

FIG. 13 is a flow-chart of an operation of the user's terminal in the third embodiment.

FIG. 14 is a flow-chart of an operation of the first server in the third embodiment.

FIG. 15 is a block diagram of a system for delivering non-gratuitous contents, in accordance with the fourth embodiment of the present invention.

FIG. 16 is a flow-chart of an operation of the user's terminal in the fourth embodiment.

FIG. 17 is a flow-chart of an operation of the content server in the fourth embodiment.

FIG. 18 is a block diagram of the first content-relay device in the fourth embodiment.

### DESCRIPTION OF THE PREFERRED EMBODIMENTS

Preferred embodiments in accordance with the present invention will be explained hereinbelow with reference to drawings.

[First Embodiment]

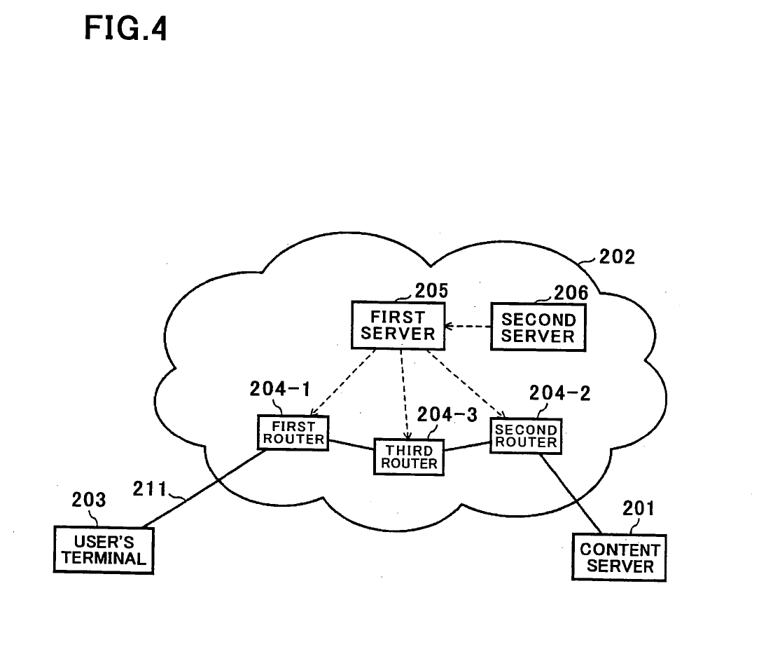

FIG. 4 is a block diagram of a system for delivering non-gratuitous contents to a user, in accordance with the first embodiment of the present invention.

The system is comprised of a user's terminal 203, a content server 201, and a communication network 202 through which the user's terminal 203 and the content server 201 transmit data to each other. The communication network 202 includes a first router 204-1, a second router 204-2, a third router 204-3, a first server 205 for administrating bands, and a second server 206 for settling accounts and make authentication of users.

The content server 201 is connected to the communication network 202 comprised of the Internet or CATV (Community Antenna TeleVision; CAble TeleVision). The user's terminal 203 is comprised of communication terminal such as a personal computer or a game-player terminal. The user's terminal 203 is connected the first router 204-1. The content server 202 is connected to the second router 204-2. The third router 204-3 is connected to both of the first and second routers 204-1 and 204-2. That is, the user's terminal 203 and the content server 201 are connected to each other through the first to third routers 204-1, 204-2 and 204-3. The first server 205 administrates each of bands of the first to third routers 204-1, 204-2 and 204-3. In the first embodiment, the first and second servers 205 and 206 are administrated by a service-provider administrating the communication network 202.

The user's terminal 203 includes a central processing unit (CPU, not illustrated) therein. The user's terminal 203 executes a control program stored in a recording medium (not illustrated) mounted therein, such as a hard disc or a magnetic disc, to thereby store various contents in a memory (not illustrated) such as a random access memory (RAM), and reproduce audio and/or image contents. The user's terminal 203 is connected to the communication network 202 through an access line 211. The user's terminal 203 is designed to have a web browser function for transmitting data to the content server 201.

The content server 201 is administrated by a content-provider. The content server 201 is comprised of a data-processing apparatus such as a work station, and has a memory device (not illustrated) having a high capacity. Contents as data to be purchased by a user, such as program, voice data and/or image data, are stored in the memory device. The content server 201 is designed to have functions of working as a web server for presenting the contents to the user's terminal 203, and making inquiry to the second server 206 to authenticate a user which made access to the content server 201 to purchase contents. These functions are accomplished by operating a hardware prepared for accomplishing the functions, or executing the above-mentioned control program.

The first server 205 is comprised of a data-processing apparatus such as a work station, similarly to the content server 201.

The first server 205, on receipt of an instruction from the second server 206, checks band resources in the communication network 202, and assures a band through which contents are transmitted from the content server 201 to the user's terminal 203. Specifically, the first server 205 constructs a channel through which the content server 201 and the user's terminal 203 are connected to each other, by selecting the first to third routers 204-1 to 204-3, and assigns a band to the first to third routers 204-1 to 204-3 for transferring contents which a user of the terminal 203 has purchased.

When routers are selected for constructing a channel between the content server 201 and the user's terminal 203, it is naturally confirmed whether a requisite band can be assigned to the selected routers at a predetermined period of time for transmitting contents to the user's terminal 203 from the content serve 201.

The second server 206 is comprised of a data-processing apparatus such as a work station, similarly to the content server 201 and the first server 205.

The second server 206 authenticate a user and settles account for a fee at which a user purchased contents in response to an inquiry transmitted from the content server 201, for instance, based on information comprised of identification (ID) and a password. Specifically, the second server 206 checks whether a user who intends to purchase contents made contract to use the system. In addition, the second server 206 has a database storing therein data indicative of content-purchase history for each of users, and settles account for a fee at which a user purchased contents.

The first to third routers 204-1 to 204-3 partially constitute the communication network 202 together with other routers (not illustrated). The first to third routers 204-1 to 204-3 are selected as network devices necessary for assuring a requisite band, among routers arranged on a channel between the user's terminal 203 and the content server 201.

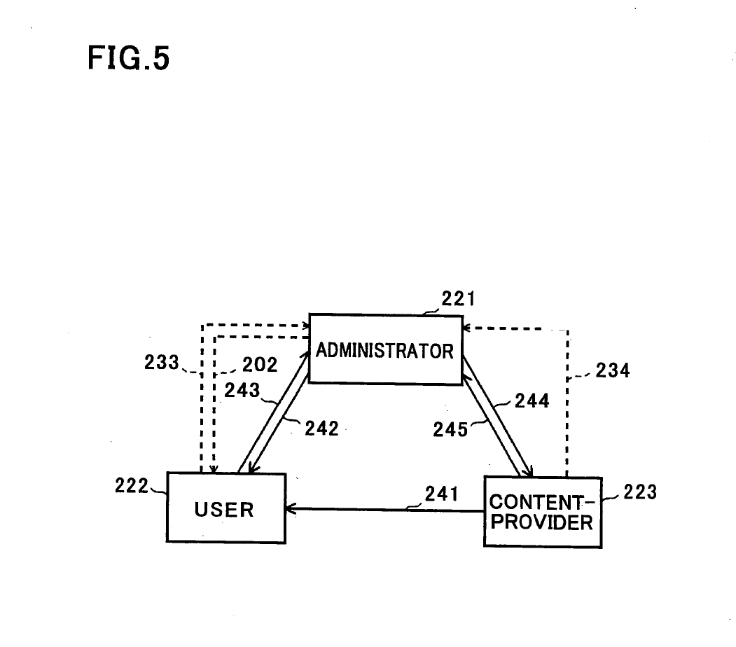

FIG. 5 shows a relation among a user 222 having the user's terminal 203, an administrator 221 operating the communication network 202, and a content-provider 223 having the content server 201.

The first and second servers 205 and 206 and the first to third routers 204-1 to 204-3 are operated by the administrator 221 who operates the system in accordance with the first embodiment. Both of the user 222 having the user's terminal 203 and the content-provider 223 having the content server 201 make contract with the administrator 221 for data transmission therethrough, and pays network communication fees 233 and 234 to the administrator 221.

In the system in accordance with the first embodiment, the content-provider 223 provides contents 241 to the user 222, and the administrator 221 assures a band resource 242 for a channel between the content server 201 and the user's terminal 203 during a period of time in which contents are transmitted to the user's terminal 203 from the content server 201. The user 222 pays only content fee 243 to which the user 222 agreed when purchasing the contents 241, to the administrator 221. The user 222 never pays a fee to the content-provider 223. The administrator 221 pays a fee equal to the content fee 243 to the content-provider 223 as a content fee 244, and the content-provider 223 pays an agent fee 245 to the administrator 221, since the administrator 221 receives a total fee from the user 222 on behalf of the content-provider 223. The agent fee 245 includes a fee for assuring the band resource 242.

Namely, a fee at which the user 222 purchased the contents 241 is equal to a sum of a content fee to be paid to the content-provider 223 and the agent fee 245 to be paid to the administrator 221 as a fee for assuring the band resource 242 for transmission of the contents 241 and further for receiving a fee from the user 222 on behalf of the content-provider 223.

The user 222 purchases the contents 241 through the communication network 202, paying the communication fee 233. Comparing to a case that the user 222 purchases a music CD (compact disc) at a CD shop, the contents 241 do not have attachments such as a case and a manual, and hence, the user 222 can naturally purchase the contents 241 at a lower price than a price of the same in a CD shop. However, there is no explicit standard about price reduction the user 222 could have when he/she purchases the contents 241 through the communication network 202. On the other hand, the user 222 could have an advantage that he/she can rapidly get his/her favorite contents without wasting a traffic fee for going to a CD ship, and further without wasting time.

In addition, as to contents in which various events such as a concert, a professional sport gate or a wedding are broadcast at real-time, an existing CD shop cannot sell such contents, and hence, there is no standard about a content fee for such contents. In particular, a fee for such contents to be broadcast at real-time is dependent highly on a skill of the administrator 221.

Hence, it is reasonable to consider the content fee 243 which the user 222 pays to the administrator 221, as a fee at which the user 222 purchases contents, when he/she purchases contents through a network. Assuming that the user 222 purchases a music CD from the content-provider 223 through a network, if the user 222 feels that a fee to be paid to the administrator 21 is high, the user 222 may purchase the music CD at an existing CD shop, in which case, a content-provider's business of providing contents cannot be continued. In addition, if there is much possibility of success in a business in which the communication network 202 such as the Internet is used, many competitors will appear. Among such competitors, one or more competitors accepted to the user 222 can survive. Accordingly, there is much possibility that the content fee 243 which the administrator 221 receives from the user 222 is accepted as a fee for purchasing contents. Furthermore, it is not necessary for the user 222 to separately pay an extra communication fee, and to pay a sum of a content fee and an explicitly indicated communication fee. Hence, the system has an advantage that the user 222 does not have feeling of resistance to purchase of contents and associated payment.

An example of the system is explained hereinbelow with reference to FIGS. 4 to 10. It is assumed that the user 222 purchases a particular content such as classic music.

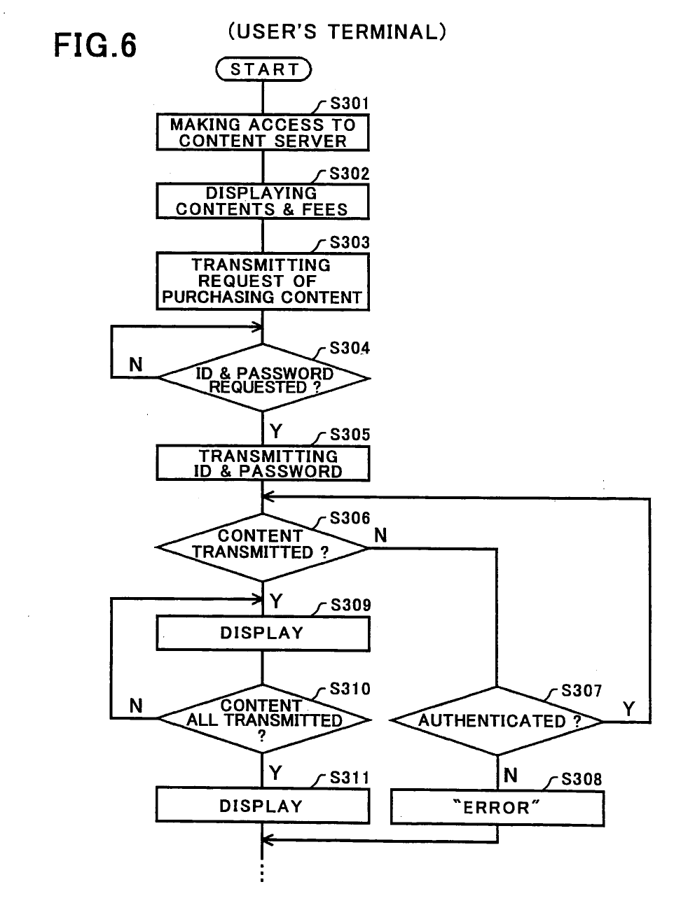

FIG. 6 is a flow-chart showing an operation of the user's terminal 203.

The user 222 starts a browser stored in the terminal 203 to make access to URL (Uniform Resource Location) of the content server 201 in step S301. As a result, contents stored in the content server 201 are displayed in a display screen (not illustrated) of the user's terminal 203.

A content fee is also displayed together with contents in step S302. Data volume, a data-transmission rate (band) and/or a time necessary for downloading a content are also displayed in the display screen.

When the user 222 selects a content to be purchased, and agrees to a content fee of the selected content, the user 222 transmits a request of purchasing the selected content to the content server 201 through his/her terminal 203, in step S303.

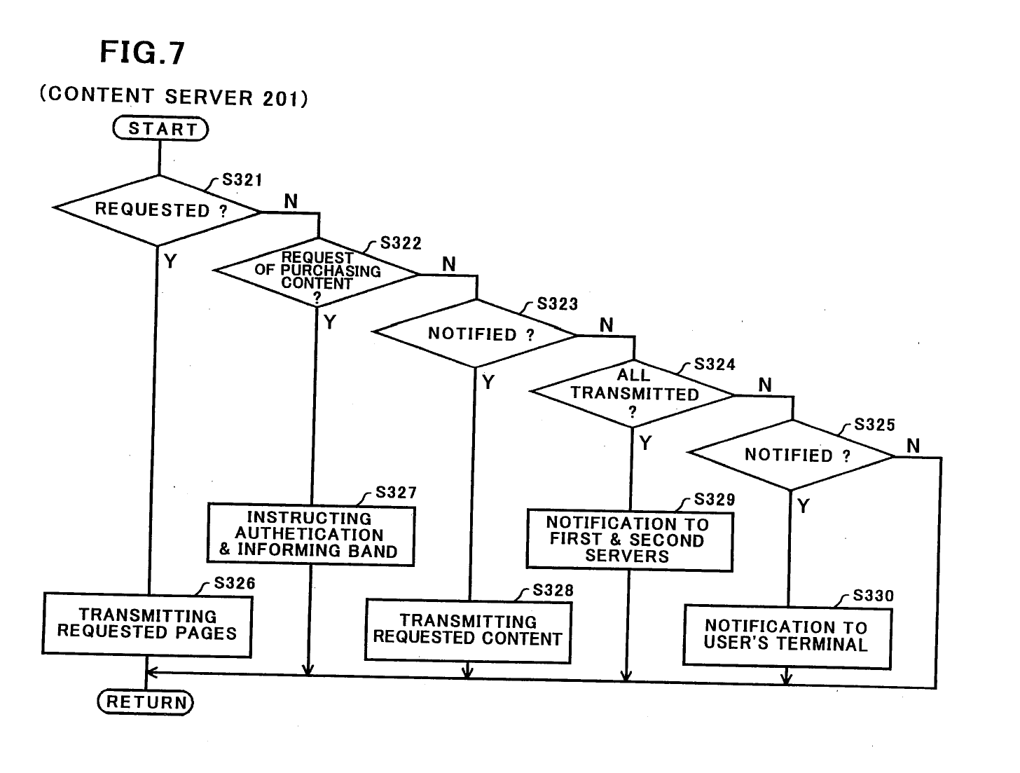

FIG. 7 is a flow-chart of an operation of the content server 201.

The content server 201 repeatedly checks whether a request of monitoring contents is received (step S321), a request of purchasing a particular content is received (step S322), whether notification that a band has been assured is received (step S323), whether notification that contents have been transmitted to the user 222 is received (step S324), and whether notification that a band has been released is received (step S325).

When the user's terminal 203 makes access to a homepage of the content server 201, and requests the content server 201 to see requisite pages (YES in step S321), the content server 201 transmits text data and/or image data of the requested pages to the user's terminal 203, in step S326. Thus, the user 222 can see pages one by one in the homepage of the content server 201.

When the user 222 selects a content or contents to be purchased, at least the content(s) and a content fee(s) thereof are displayed in a display screen (not illustrated) of the user's terminal 203. For instance, if each of a plurality of pieces of classic music is equal in a fee to one another, a total fee of them may be displayed. In the displayed content fee, a specification is not displayed. Namely, a fee for assuring a band, a fee only for purchasing a piece of classic music, and so on are not displayed in detail. A total fee for purchasing and downloading a piece of music is displayed.

Seeing a content and its fee displayed in a display screen of the user's terminal 203, the user 222 transmits a request of purchasing the content to the content server 201. On receipt of the request (YES in step S322), the content server 201 instructs the second server 206 to authenticate the user 222, and informs the first server 205 of a band necessary for transmitting the content which the user 222 has purchased, in step S327. This is because the first server 205 is designed to determine a minimum band in accordance with a selected content for preventing data from being partially dropped.

Referring back to FIG. 6, after the user 222 transmitted a request of purchasing a particular content to the content server 201 (step S303), the user 222 waits for being requested to input ID and/or a password for account settlement from the second server 206, in step S304.

If requested (YES in step S304), the user 222 transmits his/her ID and password to the second server 206, in step S305. The ID and password are transmitted to the second server 206 in enciphered form such as SSL (Secure Sockets Layer), and hence, the content-provider 223 cannot understand them.

After transmission of the ID and password, the user 222 waits for the content to be transmitted to the user's terminal 203, in step S306.

If a combination of the transmitted ID and password is not correct, the second server 206 transmits a notification “NOT AUTHENTICATED” to the user's terminal 203 (NO in step S307), in which case, “ERROR” is displayed in a display screen of the user's terminal 203, in step S308. The user 222 is given an opportunity of transmitting his/her ID and password again to the content server 201.

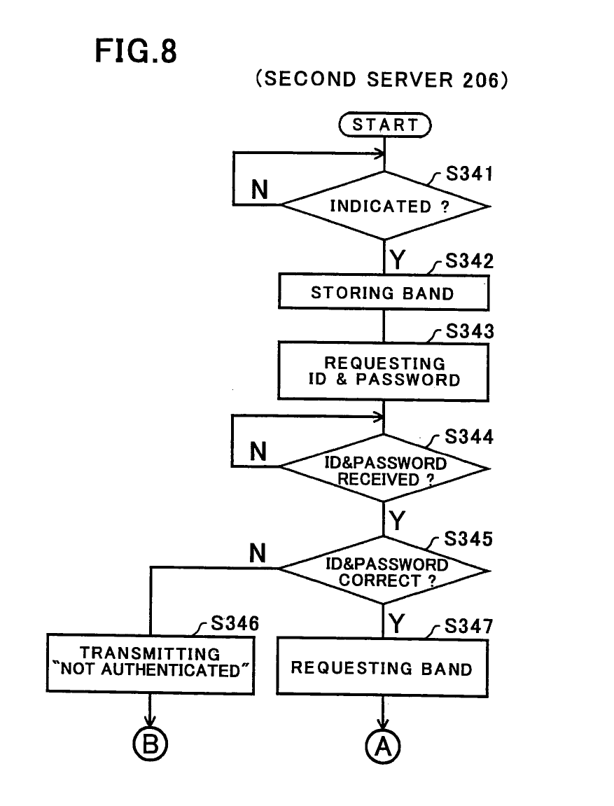

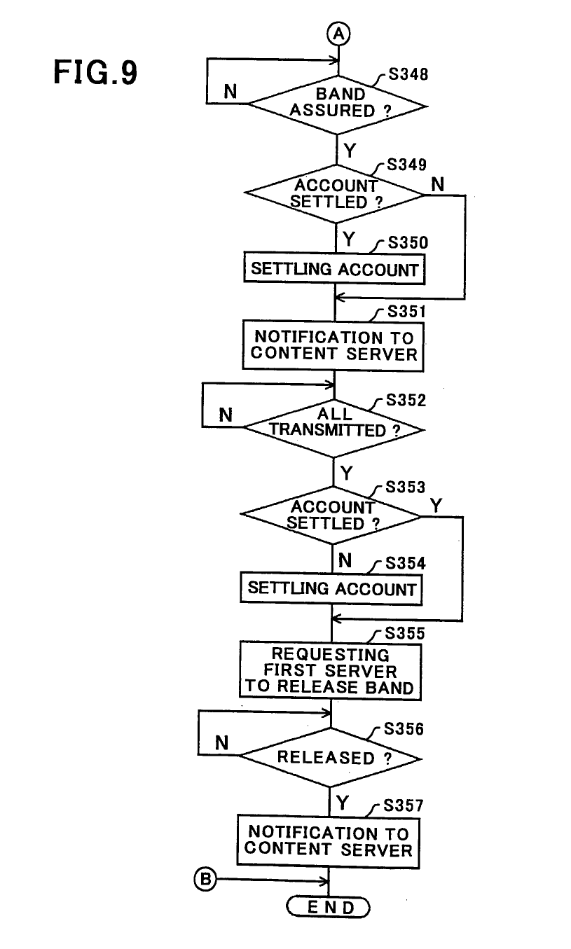

FIGS. 8 and 9 are flow-charts of an operation of the second server 206.

The second server 206 waits for an indication of authenticating the user 222 (step S327 in FIG. 7) from the content server 201 in step S341 in FIG. 8.

On receipt of the indication (YES in step S341), the second server 206 temporarily stores the received indication and a band necessary for transmitting the content transmitted from the content server 201, in a memory (not illustrated), as a pair, in step S342.

Then, the second server 206 requests the user's terminal 203 to transmit the ID and password of the user 222, in step S343.

The second server 206 awaits transmission of the ID and password from the user's terminal 203 in step S344.

On receipt of the ID and password (step S305 in FIG. 6) from the user's terminal 203 (YES in step S344), the second server 206 checks whether the ID and password are correct or not, in step S345.

If they are not correct (NO in step S345), the second server 206 informs the user's terminal 203 that the user 222 is not authenticated, in step S346. Thus, the second server 206 ends its operation (END in FIG. 9). The second server 206 may request the user 222 to transmit his/her ID and password again.

If the ID and password are correct (YES in step S345), the second server 206 reads the band out of the memory, which was stored in the memory in step S342, and requests the first server 205 to assure the band, in step S347.

After the band was assured (YES in step S348 in FIG. 9), the second server 206 checks whether account should be settled now for the content, in step S349. In this example, account of contents having known data volume (data-transmission time), such as classic music or a movie, are to be settled when a band for transmitting the content which the user 222 has purchased has been assured, in step S350. This is to prevent the user 222 from stopping transmission of the content before the content are all transmitted to the user's terminal 203 for avoiding account settlement. In contrast, account of a content such as a live concert which is not always clear as to whether it is carried out is settled just when the content has been all transmitted to the user's terminal 203.

After account is settled in step S350, the content server 201 is informed that a band necessary for transmission of the content has been assured, in step S351.

If account is not settled (NO in step S349), the content server 201 is informed that a band necessary for transmission of the content has been assured, without settling account, in step S351.

Referring back to FIG. 7, on receipt of the notification that the band necessary for transmission of the content has been assured (YES in step S323), the content server 201 starts transmitting the content having been purchased by the user 222, to the user's terminal 203, in step S328.

Thus, the user 222 knows that transmission of the contents starts (YES in step S306), and a display of the user's terminal 203 displays a message indicating that the content is now being received, in step S309.

When the transmission of the content has been finished (YES in step S324), the content server 201 notifies both of the second server 206 and the user's terminal 203 that the content has been all transmitted to the user's terminal 203, in step S329.

With reference to FIG. 9, on receipt of the notification indicating that the content has been all transmitted to the user's terminal 203 (YES in step S352), the second server 206 checks whether the account has been settled (step S349), in step S353. If not, the second server 206 settles account in step S354. If the account has been settled (YES in step S353), the second server 206 requests the first server 205 to release the band having been assured for transmission of the content, in step S355.

When the second server 206 is informed that the band has been released (YES in step S356), the second server 206 notifies the content server 201 that the band has been released, in step S357. Thus, the operation of the second server 206 ends.

Referring to FIG. 7 again, on receipt of the notification indicating that the band has been released from the second server 206 (YES in step S325), the content server 201 informs the user's terminal 203 that the contents has been all transmitted to the user's terminal 203, in step S330.

Being informed that the contents has been all transmitted to the user's terminal 203 (YES in step S310), the user's terminal 203 displays that transmission of the content has been finished, in a display screen thereof, in step S311. Thereafter, the user 222 may select another content or jump into another homepage.

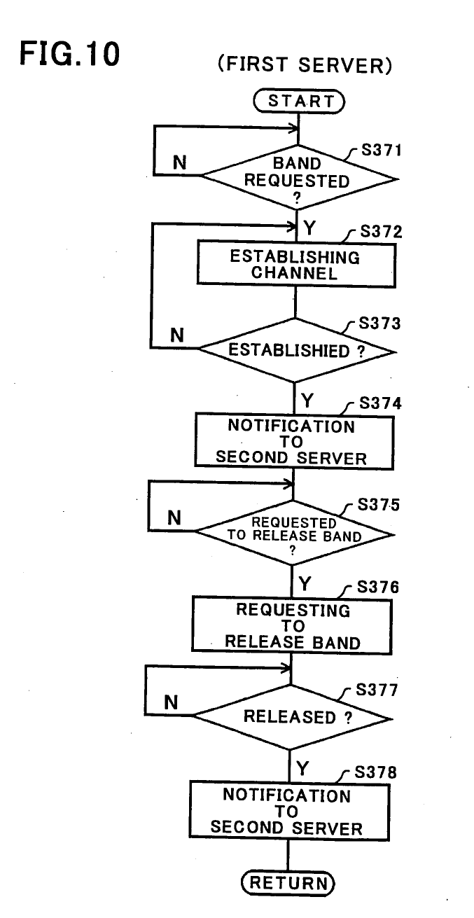

FIG. 10 is a flow-chart of an operation of the first server 205.

Receiving a request (step S347 in FIG. 8) of assignment of a requisite band from the second server 206 (YES in step S371), the first server 205 checks each of the routers to assure a requisite band, and newly establishes a channel between the content server 201 and the user's terminal 203, in step S372. For instance, if the first to third routers 204-1 to 204-3 presently establishes an existing channel, and the first to third routers 204-1 to 204-3 have a capacity to newly establish a channel for transmitting the content, a channel is newly established by the first to third routers 204-1 to 204-3 (YES in step S373). If the first to third routers 204-1 to 204-3 do not have a capacity to newly establish a channel for transmitting the content, a first router which can be connected to the user's terminal 203 and can assure a requisite band is searched, and then, other routers which can assure a requisite band are searched, extending a channel towards the content server 201.

Though a channel between the content server 201 and the user's terminal 203 is defined by means of three routers, namely, the first to third routers 204-1 to 204-3 in the first embodiment, another channel may be defined by means of routers in the number different from three.

A channel is defined with an Internet Protocol (IP) address. A requisite band may be indicated by assigning a transmission priority class which is high in a network, to a flow (transmission control protocol (TCP) session) used for transmitting the content, for instance.

When the requisite band has been assured (YES in step S373), the first server 205 informs the second server 206 that the band has been assured, in step S374.

On receipt of a request (step S355 in FIG. 9) to release the band having been assured for transmission of the content (YES in step S375), the first server 205 requests the first to third routers 204-1 to 204-3 to release the band, in step S376. This is to minimize an influence exerted on other users who receive contents through the communication network 202, by establishing a particular band only during a period of time necessary for transmitting the content which the user 222 has purchased.

When the first to third routers 204-1 to 204-3 release the band (YES in step S377), the first server 205 informs the second server 206 that the band has been released, in step S378. Thus, an operation of the first server 205 ends.

[Second Embodiment]

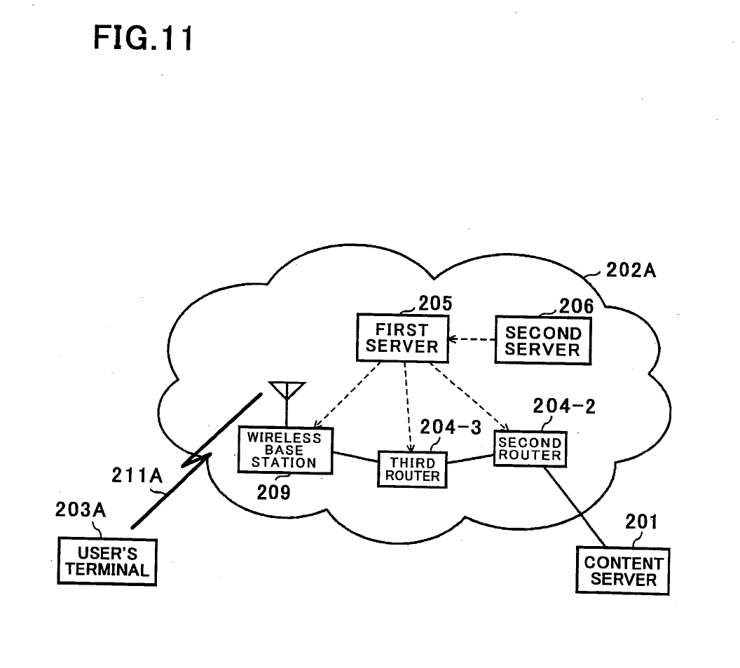

FIG. 11 is a block diagram of a system for delivering non-gratuitous contents to a user, in accordance with the second embodiment of the present invention.

Parts or elements that correspond to those of the first embodiment illustrated in FIG. 4 have been provided with the same reference numerals, and operate in the same manner as corresponding parts or elements in the first embodiment, unless explicitly explained hereinbelow.

In the second embodiment, the user's terminal 203 is comprised of a radio-signal type communication terminal such as a cellular phone or a PHS (personal handy-phone system), and is designed to connect to a wireless base station 209 partially constituting the communication network 202A, through a radio-signal access channel 211A.

Since the communication network 202A in the second embodiment includes a radio-signal network, the administrator 211 can provide wireless network connection service as well as network connection service through wires. Hence, the administrator 211 can provide not only a band resource in the communication network 202, but also a band in the radio-signal access channel 211A.

In a radio-signal band, data is transmitted at about tens kilobits per second (kbps) lower than a data-transmission rate in a network. Hence, there often occur bottle-necks in a radio-signal data transmission area during content transmission in end-to-end manner. A plurality of users commonly uses the limited number of channels in a radio-signal access channel as public service to be used for a cellular phone or PHS and so on. Accordingly, it is not preferable that a user monopolies channels for long time.

However, in the system in accordance with the second embodiment, users who intend to purchase non-gratuitous contents use radio-signal access lines by the necessary number of channels only during a period in which the contents are transmitted to the user. Hence, the user can see or listen to the content at real-time through his/her terminal 203A. When content transmission has finished, the first server 205 releases a band, resulting in that another user can use the thus released band for data transmission. Accordingly, the second embodiment makes it possible to effectively use channels.

[Third Embodiment]

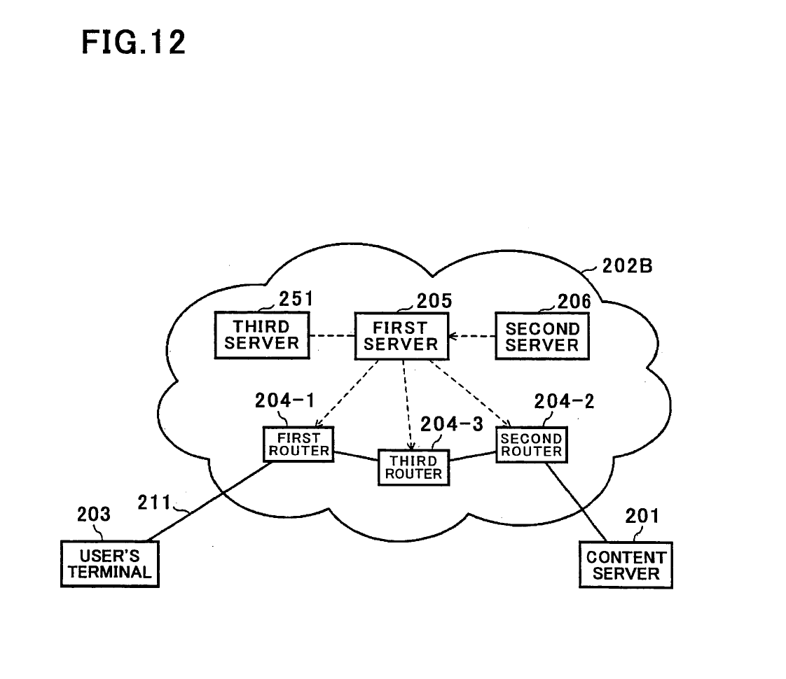

FIG. 12 is a block diagram of a system for delivering non-gratuitous contents to a user, in accordance with the third embodiment of the present invention.

Parts or elements that correspond to those of the first embodiment illustrated in FIG. 4 have been provided with the same reference numerals, and operate in the same manner as corresponding parts or elements in the first embodiment, unless explicitly explained hereinbelow.

As illustrated in FIG. 12, in the third embodiment, the first server 205 is designed to make communication not only with the second server 206, but also with a third server 251 for administrating a fee. The third server 251 receives information about traffic of a route defined by connecting the first to third routers 204-1 to 204-3 and determined by the first server 205, and calculates a fee for excessively using a band which fee compensates for other users who are restricted to have a band.

The third server 251 informs the thus calculated fee of the first server 205, and causes the first server 205 to calculate a content fee. On receipt of a request from the user 222, the first server 205 carries out routing between the content server 201 and the user's terminal 203 at that time, and then, informs traffic information of the third server 251 and causes the third server 251 to calculate the above-mentioned fee for excessively using a band. When a content fee becomes equal to a user's desired fee, the first server 205 allows the content to be transmitted to the user's terminal 203 from the content server 201.

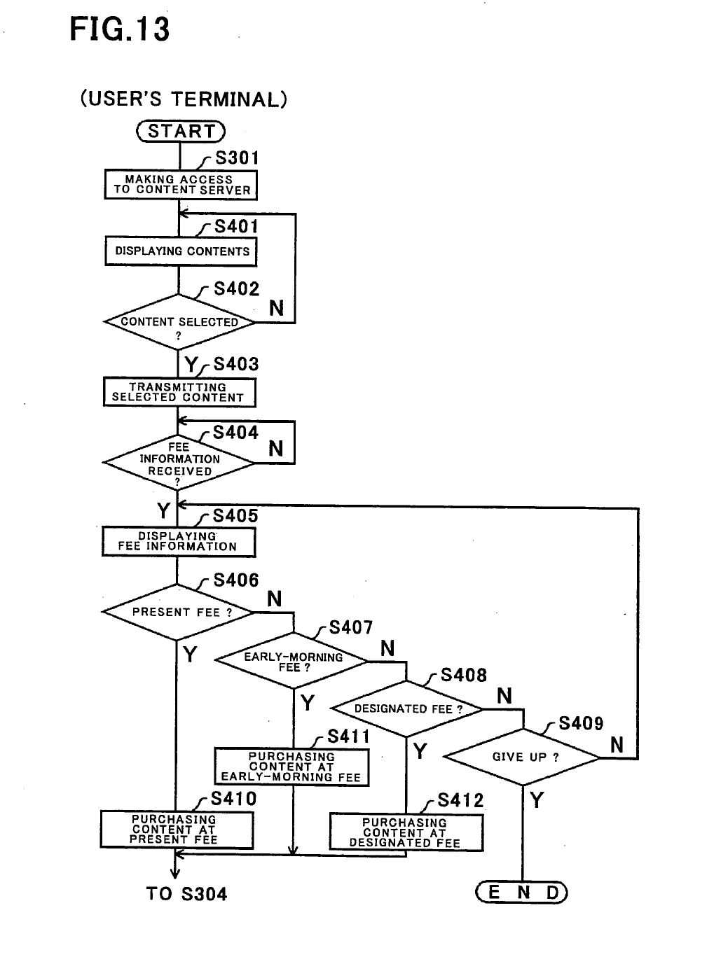

FIG. 13 is a flow-chart of an operation of the user's terminal 203 in the third embodiment.

Steps that correspond to those in FIG. 6 have been provided with the same reference numerals, and will not be explained.

When the user's terminal 203 makes access to the content server 201 in step S301, the user's terminal 203 displays contents in a display screen thereof, based on data transmitted from the content server 201, in step S401.

When the user 222 selects a content among the displayed contents (YES in step S402), the user's terminal 203 transmits data indicate of the selected content, to the content server 201, in step S403.

On receipt of the data from the user's terminal 203, the content server 201 transmits a band necessary for transmitting the content, a period of time during which the content is transmitted at the band, and data used for establishing a channel, including addresses of the content server 201 and the user's terminal 203, to the first server 205.

On receipt of them, the first server 205 temporarily determines a channel through which the content server 201 and the user's terminal 203 are connected to each other and to which a necessary band is assigned, and transmits fee information to the user's terminal 203. Fees indicated in the fee information are determined taking traffic condition at that time into consideration.

On receipt of the fee information (YES in step S404), the user's terminal 203 displays the fees in a display screen thereof, in step S405.

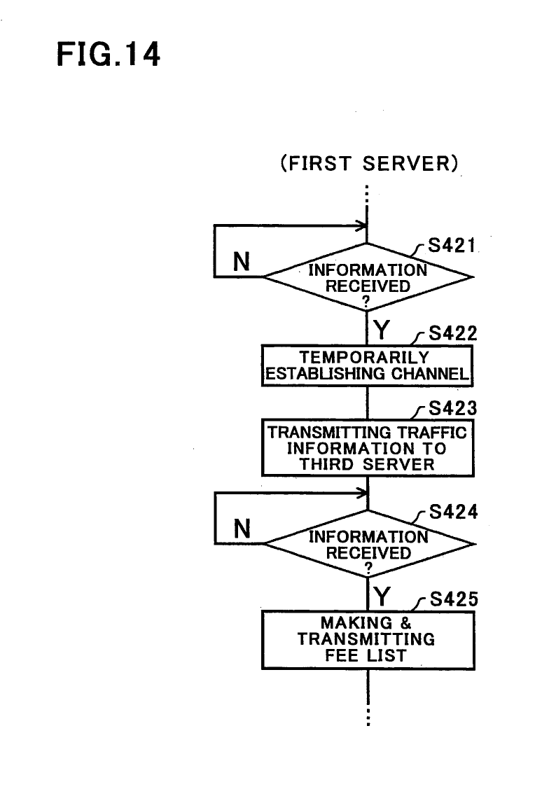

FIG. 14 is a flow-chart of an operation of the first server 205.

On receipt of information used for establishing a channel, from the user's terminal 203 (YES in step S421), the first server 205 temporarily established a channel to which a requisite band is assigned and which connects the content server 210 and the user's terminal 203 in the communication network 202B, in step S422.

For instance, if a channel is temporarily established through the use of the first to third routers 204-1 to 204-3, the first server 205 transmits traffic information indicative of traffic in each of channels connecting the content server 210 and the user's terminal 203 to each other, to the third server 251, in step S423. Based of the received traffic information, the third server 251 calculates a difference between a band usually assigned to the user's terminal 203 and a band necessary for transmission of the content, and further calculates a fee compensating for the difference, namely, a fee for excessively using a band.

Furthermore, the third server 251 studies data about a relation between the fee and time zone, and finds out a time zone in which the fee is cheapest, and a fee in the time zone, based on past statistics. Herein, it is assumed that time zone in which the fee is cheapest is early morning. The third server 251 transmits the thus found out time zone and fee o the first server 205 as fee information.

On receipt of the fee information from the third server 251 (YES in step S424), the first server 205 makes a fee list to be used for the user 222 to determined a content to be purchased, and transmits the fee list to the user's terminal 203, in step S425. Thereafter, the first server 205 awaits a reply from the user's terminal 203.

Referring back to FIG. 13, the user's terminal 203 displays the received fee list in a display screen, in step S405. Then, the user 222 selects next action, in steps S406 to S409, as follows.

If the user 222 determines to purchase a content at a fee calculated based on present traffic (YES in step S406), the user's terminal 203 informs the second server 206 that the user 222 purchases a content at the fee, in step S410. The second server 206 requests the user's terminal 203 to transmit the user's ID and password (step S343 in FIG. 8) thereto for settling account. In response, the user's terminal 203 transmits an ID and a password of the user 222 to the second server 206 (step S305 in FIG. 6).

If the user 222 determines not to purchase a content at the present fee, but to purchase a content at the cheapest fee, that is, an early-morning fee (YES in step S407), the user's terminal 203 informs the second server 206 that the user 222 purchases a content at the early-morning fee, in step S411. The second server 206 requests the user's terminal 203 to transmit the user's ID and password (step S343 in FIG. 8) thereto for settling account at the early-morning fee.

The second server 206 causes the first server 205 to release the channel having been temporarily established, and establishes again a channel between the content server 201 and the user's terminal 203 at the early-morning time zone. Then, the content which the user 222 has purchased is transmitted to the user's terminal 203 from the content server 201. In dependence on traffics on the channel, the early-morning fee may be higher or lower than a non-early-morning content fee. However, since the fee displayed at step S405 in FIG. 13 is a statistically calculated fee, the fee is fixed.

Though the early-morning fee is attractive to the user 222, the user 222 may not wait for next early morning at which he/she can get a content. In such a case, the user 222 can purchase a content at the fee indicated in step S406, if the user 222 has sufficient budget.

However, the user 222 may purchase a content, if a fee becomes 10% smaller than the present fee, though the fee is still higher than the early-morning fee, in which case, the user 222 can select an option in which the user 222 can purchase a content at a designated fee, in step S408. If the user 222 selects to purchase a content at a designated fee (YES in step S408), the user's terminal 203 informs the second server 206 that the user 222 purchases a content when a fee becomes equal to a fee designated by the user 222, in step S412.

On receipt of a notification that the user 222 purchases a content at his/her designated fee, the second server 206 causes the first server 205 to release a channel having been temporarily established. Then, the second server 206 informs the first server 205 of a requisite band, a designated fee and a present fee, and causes the first server 205 to estimate a time zone at which a present fee becomes a designated fee, based on traffic fluctuation with the lapse of time. The first server 205 and the third server 251 may cooperate with each other to estimate such a time zone. The first server 205 temporarily establishes a channel between the content server 201 and the user's terminal 203, and monitors a timing at which a present fee becomes equal to or smaller than a designated fee.

On receipt of a notification that a present fee became equal to or smaller than a designated fee, from the first server 205, the second server 206 informs the user's terminal 203 that it is a timing for the user 222 to purchase a content. If the user's terminal 203 makes a response, the second server 206 request the user's terminal 203 to transmit an ID and a password of the user 222 thereto (step S343 in FIG. 8). The reason why account is not settled when the user 222 determines to purchase a content at a designated fee is that a designated fee may be equal to or smaller than an early-morning fee.

If the user 222 gives up purchasing a content (YES in step S409), a procedure for purchasing a content ends.

In the third embodiment, the user 222 can select a fee and a timing at which the user 222 purchases a content in accordance with a content and/or a content fee, and hence the user 222 can have serviceability which the user 222 cannot have if he/she purchases a content at an existing shop.

In addition, a content which the user 222 need not to purchase in a hurry can be purchased at a timing at which traffic is not high. This reduces an influence acting on other users which influence is caused by establishing a requisite band for purchasing a content.

The third embodiment may be applied to a system including a radio-signal area, shown as the second embodiment.

[Fourth Embodiment]

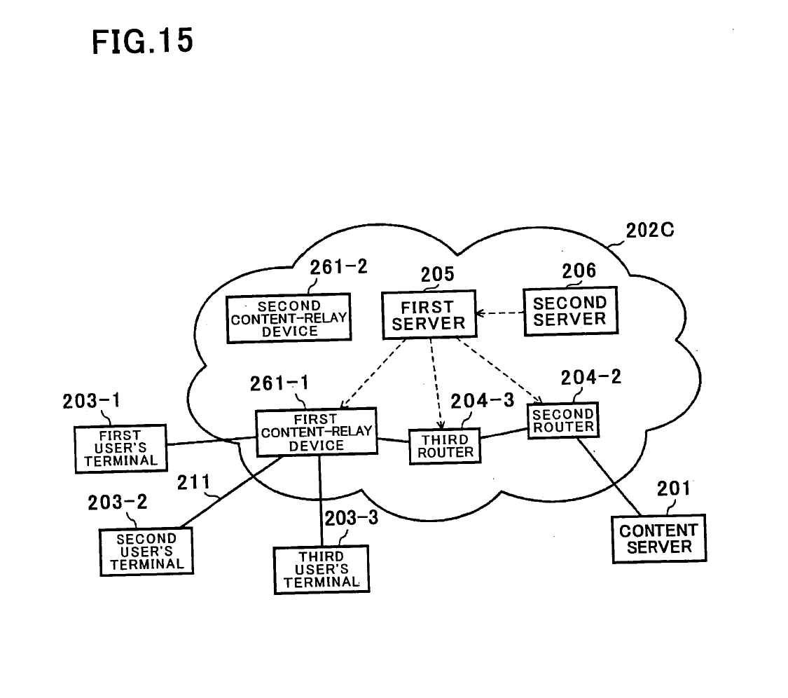

FIG. 15 is a block diagram of a system for delivering non-gratuitous contents to a user, in accordance with the fourth embodiment of the present invention.

The system in accordance with the fourth embodiment includes a first content-relay device 261-1 and a second content-relay device 261-2, each of which is a kind of a router and can buffer a content by a predetermined volume.

However, the system may include three or more content-relay devices. It is preferable that the content-relay devices are uniformly arranged in the communication network 202C.

In the fourth embodiment, the first content-relay device 261-1 is connected to first to third user's terminals 203-1 to 203-3 of users who jointly purchase a particular content. The first server 205 selects the first content-relay device 261-1 and the second and third routers 204-2 and 204-3 to establish a channel for connecting the content server 201 to the first to third user's terminals 203-1 to 203-3, and assures a band for one user.

The second server 206 settles account for a content jointly purchased by the users having the first to third user's terminals 203-1 to 203-3. Hence, a content fee can be cheaper than a content fee purchased by a single user.

Delay for waiting for users jointly purchasing a particular content is unavoidable. However, communication can be effectively made almost without delay for a content such a content of a popular artist which is expected to be purchased by a lot of users.

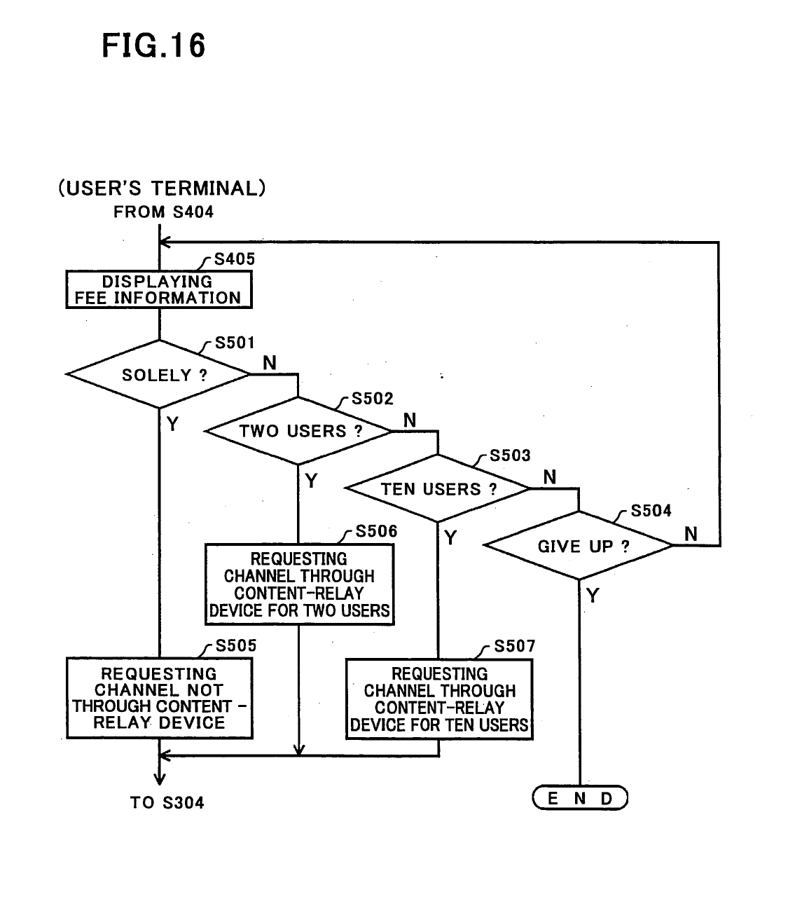

FIG. 16 is a flow-chart of an operation of each of the user's terminals 203-1, 203-2 and 203-3 in the fourth embodiment. Steps that correspond to those in FIG. 13 have been provided with the same reference numerals, and will not be explained.

When the first user's terminal 203-1, for instance, makes access to the content server 201 and indicates a content, the first server 205 transmits fee information to the first user's terminal 203-1, in step S404. The first user's terminal 203-1 displays the received fee information in a display screen thereof, in step S405. Herein, the displayed fee information is different from the same in the third embodiment.

Specifically, in order to find a channel between the first user's terminal 203-1 and the content server 201, the first server 205 carries out routing in which access channel is via the first content-relay device 261-1 located closer to the first user's terminal 203-1 in the communication network 202C than the second content-relay device 261-2, and routing access channel is via a router, for instance, the first router 204-1 illustrated in FIG. 4. Then, in the former routing, the first server 205 calculates a sum of an original content fee and a first band fee or a second band fee wherein the first band fee is a half (½) of a fee for using a requisite band to be used by a single user between the content server 201 and the first content-relay device 261-1, and the second band fee is a one-tenth (1/10) of a fee for using a requisite band to be used by a single user between the content server 201 and the first content-relay device 261-1. In the latter routing, the first server 205 calculates a content fee similarly to the first embodiment.

The first user's terminal 203-1 displays a plurality of fees including the thus calculated fees. Specifically, the first user's terminal 203-1 displays inquiries of (a) whether the user 222 solely purchases a content (step S501), (b) whether two users jointly purchase a content (step S502), (c) whether ten users jointly purchase a content (step S503), and (d) whether the user 222 ceases purchasing a content (step S504).

If the user determines to solely purchasing a content (YES in step S501), the first user's terminal 203-1 requests the second server 206 to transmit the content thereto through a channel not using the first content-relay device 261-1, in step S505. On receipt of such a request from the first user's terminal 203-1, the second server 206 removes a channel estimated to use the first content-relay device 261-1, and requests the first user's terminal 203-1 to transmit an ID and a password of the user 222 for settling account (step S304 in FIG. 6). Thereafter, there are carried out the same steps as those carried out in the first embodiment.

If the user 222 selects purchasing a content jointly by two users (YES in step S502), the first user's terminal 203-1 requests the second server 206 to start transmission of the content through the first content-relay device 261-1 when two users are identified, in step S506. The second server 206 releases a channel estimated to use the first router 204-1, and requests the first user's terminal 203-1 to transmit an ID and a password of the user 222 for settling account (step S304 in FIG. 6).

The second server 206 releases a channel in which the first content-relay device 261-1 is used. The second server 206 is designed to check whether other user (for instance, a user of the second user's terminal 203-2) requests to transmit the same content as one purchased by the user 222 of the first user's terminal 203-1, to his/her terminal (the second user's terminal 203-2) through the first content-relay device 261-1. If the second server 206 finds other user (for instance, a user of the second user's terminal 203-2) purchasing a content jointly with the user 222 of the first user's terminal 203-1, the second server 206 assures a requisite band necessary for transmitting a content to both of the first and second user's terminals 203-1 and 203-2 through the first content-relay device 261-1, immediately after settling account. The content is transmitted at a band assured for a single user from the content server 201 to the first content-relay device 261-1, and further transmitted in parallel at a band assured for two users from the first content-relay device 261-1 to the first and second user's terminals 203-1 and 203-2.

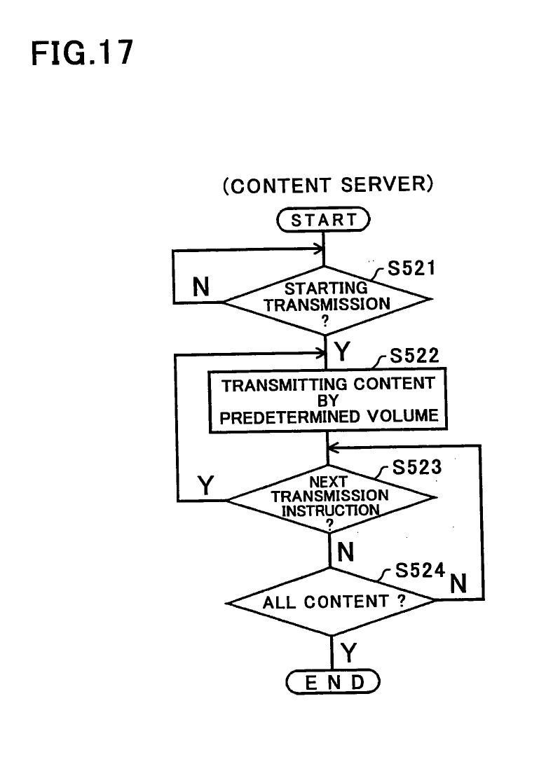

FIG. 17 is an operation carried out by the content server 201 when a content jointly purchased by users is transmitted.

On receipt of an instruction of transmission of a content having been purchased jointly by users (YES in step S521), the content server 201 transmits a content to the second router 204-2 illustrated in FIG. 15 by a predetermined volume from the head of the content, in step S522.

If the content server 201 receives an acknowledge signal from the second router 204-2 or receives a next instruction of content-transmission after the lapse of a predetermined period of time (YES in step S523), the content server 201 transmits the content to the second router 204-2 by the next predetermined volume, in step S522.

The content server 201 repeatedly carries out the above-mentioned steps until the requested content are all transmitted to the second router 204-2, in step S524.

As mentioned above, the content having been purchased jointly by a plurality of users are intermittently transmitted to the second router 204-1 from the content server 201, and then, further intermittently transmitted to the third router 204-3. The third router 204-3 transmits the received content to the first content-relay device 261-1 in the same way.

In place of being intermittently transferred, a content may be transmitted by inserting an eye-mark signal into a trail of each of predetermined volumes.

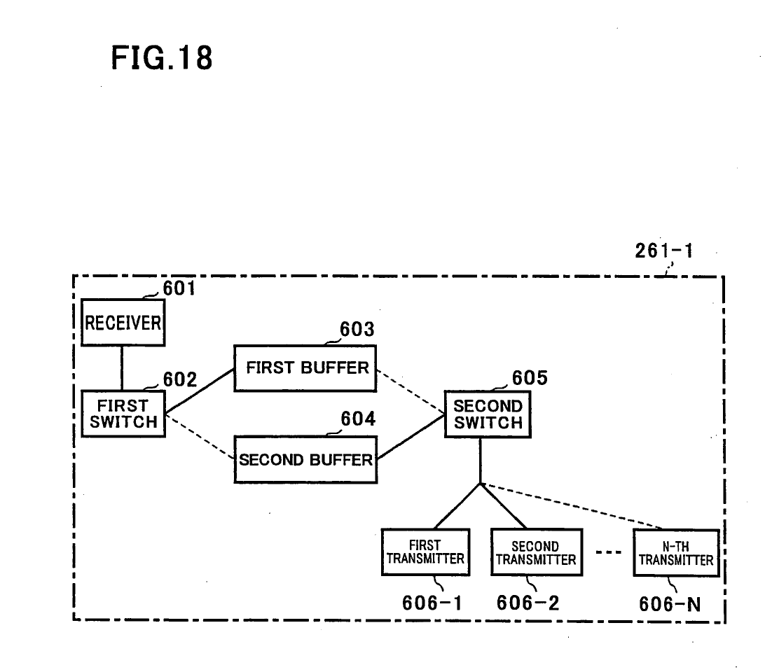

FIG. 18 is a block diagram of the first content-relay device 261-1 receiving a content jointly purchased by users, from the content server 201. Other content-relay devices including the second content-relay device 261-2 have the same structure as that of the first content-relay device 261-1.

The first content-relay device 261-1 is comprised of a receiver 601, a first switch 602, a first buffer 603, a second buffer 604, a second switch 605, and first to N-th transmitters 606-1 to 606-N wherein N is an integer equal to or greater than one.

The receiver 601 receives a content transmitted through the communication network 202C, and transmits the received content to the first switch 602. The first switch 602 is connected at its output to the first buffer 603 and the second buffer 604. A content is transmitted alternately to the first and second switches 603 and 604 by the above-mentioned predetermined volume.

Each of the first and second buffers 603 and 604 is comprised of a FIFO (a first-in first-out memory), for instance. Data constituting a content is read out of the first and second buffers 603 and 604 in an order of being input to the first and second buffers 603 and 604.

The first and second buffers 603 and 604 are electrically connected at their outputs to the second switch 605. The second switch 605 selects the first buffer 603 for reading data therefrom, if the first switch 602 selects the second buffer 604, and vice versa.

The second switch 605 is electrically connected at its output to the first to N-th transmitters 606-1 to 606-N. Transmitters among the first to N-th transmitters 606-1 to 606-N are selected by the number equal to the number of users jointly purchasing a content.

It is assumed that the first user's terminal 203-1 selects to purchase a content jointly with another user, (YES instep S502 in FIG. 16), that is, two users jointly purchase a content.

A content starts being transmitted when a user of the second user's terminal 203-2 is determined as a joint purchaser of the user 222 of the first user's terminal 203-1. The second switch 605 of the first content-relay device 261-1 is electrically connected to two transmitters, for instance, the first and second transmitters 606-1 and 606-2. For instance, the first transmitter 606-1 makes communication with the first user's terminal 203-1, and the second transmitter 606-2 makes communication with the second user's terminal 203-2.

On receipt of a content from the content server 201 every predetermined volume, the first and second transmitters 606-1 and 606-2 transmit the received content to the first user's terminal 203-1 and the second user's terminal 203-2 in parallel. Hence, a band necessary for transmitting a content to the first content-relay device 261-1 from the content server 201 may be assured as a band used for a single user, ensuring reduction in economic burden in joint purchasers. In addition, it is possible to reduce a burden in the communication network 202C.

Referring back to FIG. 16, if ten users jointly purchase a content (YES in step S503), the first user's terminal 203-1 requests the second server 206 to transmit a content through the first content-relay device 2651-1 and start transmission of a content when ten users are identified, in step S507. The second server 296 releases a channel estimated to use the first router 204-1, and requests the first user's terminal 203-1 to transmit an ID and a password of the user 222 for settling account (step S304 in FIG. 6).

The second server 206 releases a channel in which the first content-relay device 261-1 is used. The second server 206 is designed to check whether other user (for instance, a user of the second user's terminal 203-2) requests to transmit the same content as one purchased by the user 222 of the first user's terminal 203-1, to his/her terminal (the second user's terminal 203-2) through the first content-relay device 261-1. If the second server 206 finds other nine users purchasing a content jointly with the user 222 of the first user's terminal 203-1, the second server 206 assures a requisite band necessary for transmitting a content to the ten users through the first content-relay device 261-1, immediately after settling account. The content is transmitted at a band assured for a single user from the content server 201 to the first content-relay device 261-1, and further transmitted in parallel at a band assured for ten users from the first content-relay device 261-1 to the ten user's terminals.

Even if eleven or more users jointly purchase a popular content to which many accesses are made, a communication fee can be reduced as much as possible, though slight relay is caused. By checking whether a content is a popular content to which many accesses are made, and transmitting a content through one of the content-relay devices through a part or all of a pre-arranged channel, it would be possible to make effective communication, in which case, it is not always necessary for the content-relay device to make direct communication with the user's terminals.

For instance, it is assumed that a Japanese user purchases a content stored in the content server 201 arranged in the United States of America. Even if a content is transmitted from the content server 201 to a content-relay server arranged in Japan, and thereafter, to a plurality of user's terminals through a plurality of routers, a requisite band between the United States of America and Japan can be effectively used, ensuring reduction in a content fee.

The fourth embodiment may be designed to include the wireless base station 209, similarly to the second embodiment. For instance, the wireless base station 209 may be designed to have a function of a content-relay device, which ensures reduction in a requisite band in a network such as Internet.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2002-301716 filed on Oct. 16, 2002 including specification, claims, drawings and summary is incorporated herein by reference in its entirety.

What is claimed is:

1. A system for delivering contents to a user, comprising:
(a) a content server which provides a content a user selected, to said user;
(b) a user's terminal which transmits an indication of a user's desired content among contents provided by said content server, to said content server; and
(c) a network system which assigns a band necessary for transmission of said content to a channel through which said content is transmitted from said content server to said user's terminal, only during said content is being transmitted, receives a content fee from said user, pays said content fee to said content server, and receives a fee for assuring said band and transmitting said content to said user on behalf of said content server, from said content server.

2. The system as set forth in claim 1, wherein said content server shows said content fee to said user, guaranteeing to assure said band and transmitting said content to said user, and provides said content at said content fee to said user.

3. The system as set forth in claim 1, wherein said network system includes a first server for assigning said band to said channel.

4. The system as set forth in claim 1, wherein said user's terminal is comprised of a wireless terminal, and receives said content from said content server through a wireless base station and one or more routers.

5. The system as set forth in claim 1, wherein said content server detects traffic in a channel between said content server and said user's terminal, and calculates a higher content fee as the detected traffic is higher, as a band necessary for reproducing said content is broader than a band usually acquired during a time zone in which said content is transmitted, or as transmission of said content needs a longer period of time, the thus calculated content fee being shown to said user's terminal.

6. The system as set forth in claim 5, wherein said user's terminal designates a fee at which said user determines to purchase said content, and said network system makes a contract with said user when said content fee becomes equal to or smaller than said user's designated fee.

7. The system as set forth in claim 5, wherein said user's terminal designates a fee at which said user determines to purchase said content, and informs said content server that said user purchases said content when informed that said content fee becomes equal to or smaller than said user's designated fee, and wherein said network system informs said user's terminal that said content fee becomes equal to or smaller than said user's designated fee, and considers that a purchase contract of said content is established when said user's terminal informs said network system that said user determines to purchase said content.

8. The system as set forth in claim 1, wherein said network system includes content-relay devices arranged in said network system, said content-relay devices each temporarily storing said content transmitted from said content server, by predetermined volume, and transmitting said content stored therein to a designated address by said predetermined volume, and
said network system selects one of said content-relay devices having a band at which a content can be transmitted to a group of user's terminals which jointly purchase a particular content, assures a band resource used for a single user for transmitting said particular content between said selected content-relay device and said content server, and further assures a band resource for transmitting said particular content between said selected content-relay device and each of said group of user's terminals.

9. The system as set forth in claim 8, wherein said content server indicates both a fee at which said user can solely purchase a content and a fee at which a predetermined number of users can jointly purchase said content, and provides said content to said user or users at a fee selected by said user or users.

10. A method of delivering contents to a user in a content-delivering system including a content server storing contents therein, a user's terminal which purchases a content among said contents stored in said content server, and a network system through which said content server and said user's terminal makes communication with each other, comprising:
(a) said user's terminal transmitting an indication of a user's desired content among said contents provided by said content server, to said content server;
(b) said network system assigning a band necessary for transmission of said content to a channel through which said content is transmitted from said content server to said user's terminal, only during said content is being transmitted;
(c) said network system receiving a content fee from said user;
(d) said network system paying said content fee to said content server; and
(e) said network system receiving a fee for assuring said band and transmitting said content to said user on behalf of said content server, from said content server.

11. The method as set forth in claim 10, further comprising (f) said content server showing said content fee to said user, guaranteeing to assure said band and transmitting said content to said user, said content being provided at said content fee to said user.

12. The method as set forth in claim 10, wherein said user's terminal is comprised of a wireless terminal, receiving said content from said content server through a wireless base station and one or more routers.

13. The method as set forth in claim 10, further comprising:
said content server detecting traffic in a channel between said content server and said user's terminal; and
said content server calculating a higher content fee as the detected traffic is higher, as a band necessary for reproducing said content is broader than a band usually acquired during a time zone in which said content is transmitted, or as transmission of said content needs a longer period of time, the thus calculated content fee being shown to said user's terminal.

14. The method as set forth in claim 13, further comprising:
said user's terminal designating a fee at which said user determines to purchase said content;
and said network system making a contract with said user when said content fee becomes equal to or smaller than said user's designated fee.

15. The method as set forth in claim 13, further comprising:
said user's terminal designating a fee at which said user determines to purchase said content;
said user's terminal informing said content server that said user purchases said content when informed that said content fee becomes equal to or smaller than said user's designated fee;
said network system informing said user's terminal that said content fee becomes equal to or smaller than said user's designated fee; and
said network system considering that a purchase contract of said content is established when said user's terminal informs said network system that said user determines to purchase said content.

16. The method as set forth in claim 10, wherein said network system includes content-relay devices arranged in said network system,
further comprising:
said content-relay devices each temporarily storing said content transmitted from said content server, by predetermined volume;
said content-relay devices each transmitting said content stored therein to a designated address by said predetermined volume;
said network system selecting one of said content-relay devices having a band at which a content can be transmitted to a group of user's terminals which jointly purchase a particular content;
said network system assuring a band resource used for a single user for transmitting said particular content between said selected content-relay device and said content server; and
said network system assuring a band resource for transmitting said particular content between said selected content-relay device and each of said group of user's terminals.

17. The method as set forth in claim 16, further comprising said content server indicating both a fee at which said user can solely purchase a content and a fee at which a predetermined number of users can jointly purchase said content, providing said content to said user or users at a fee selected by said user or users.
